(19) United States
(12) Patent Application Publication
(10) Pub. No.: US 2023/0279188 A1
(43) Pub. Date: Sep. 7, 2023

(54) PIGMENT DISPERSOID AND METHOD FOR MANUFACTURING THE SAME

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); Chen-Ho Lai, TAIPEI (TW)

(21) Appl. No.: 17/955,633

(22) Filed: Sep. 29, 2022

(30) Foreign Application Priority Data
Mar. 4, 2022 (TW) 111107887

(51) Int. Cl. C08J 3/22; C08L 27/06; C08L 91/06

(52) U.S. Cl. CPC C08J 3/22; C08L 27/06; C08L 91/06; C08L 2310/00; C08L 2201/54; C08J 2327/06; C08J 2391/06; C08J 2477/00; C08J 2479/02

(57) ABSTRACT

A pigment dispersoid and a method for manufacturing the pigment dispersoid are provided. The method for manufacturing the pigment dispersoid includes the following steps. A pigment powder, a dispersant, and a plasticizer are mixed to form a dispersing solution. The dispersing solution is homogenized to form a pigment slurry. A carrier polymer powder is added into the pigment slurry to form a liquid mixture. The liquid mixture is stirred at a temperature ranging from 80° C. to 100° C. to form the pigment dispersoid. The plasticizer prompts the plasticization of the carrier polymer powder such that the pigment slurry is adsorbed by the carrier polymer powder during the plasticization to form the pigment dispersoid.

### CROSS-REFERENCE TO RELATED PATENT APPLICATION

This application claims the benefit of priority to Taiwan Patent Application No. 111107887, filed on Mar. 4, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a pigment dispersoid and a method for manufacturing the same, and more particularly to a pigment dispersoid that can be side fed in an extruder and a method for manufacturing the same.

### BACKGROUND OF THE DISCLOSURE

In order for products to meet appearance requirements in the market, pigment powder or a pigment masterbatch is usually added in a polymer material for manufacturing polymer products having different colors.

Despite having low cost, the pigment powder is easily dampened due to having a powder form, which causes storage problems. In addition, the pigment powder has a low flowability during processing such as to negatively affect a dispersity of the pigment powder. When the pigment powder has poor dispersity, a coloring effect for the products becomes unstable, which reduces a quality of the products. Moreover, a dust which raises concerns for operational safety is generated when feeding the pigment powder for producing products.

By using the pigment masterbatch, problems in storage and in usage of the pigment powder (i.e., the dust from the pigment powder) may be overcome. However, production cost and energy consumption for manufacturing the pigment masterbatch are high, and the pigment masterbatch is manufactured by a specific device through a molten extrusion process (e.g., extruded by using a screw). Commercially, manufacturers increase a concentration of pigment in the pigment masterbatch, so as to reduce the production cost of the pigment masterbatch. Therefore, in the conventional pigment masterbatch, dispersing the pigment having a high concentration is difficult to achieve, and as a result, the product may exhibit problems such as large color deviation and color spots on a surface of the product.

Therefore, how to provide a new pigment by improving a component or a structure so as to overcome the abovementioned problems has become one of the important issues to be solved in the industry.

### SUMMARY OF THE DISCLOSURE

In response to the above-referenced technical inadequacies, the present disclosure provides a pigment dispersoid and a method for manufacturing the pigment dispersoid.

In one aspect, the present disclosure provides a method for manufacturing the pigment dispersoid. The method for manufacturing the pigment dispersoid includes the following steps. Pigment powder, a dispersant, and a plasticizer are mixed to form a dispersing solution. The dispersing solution is homogenized to form a pigment slurry. A carrier polymer powder is added into the pigment slurry to form a liquid mixture. The liquid mixture is stirred at a temperature ranging from 80° C. to 100° C. to form the pigment dispersoid. The plasticizer promotes a plasticization of the carrier polymer powder such that the pigment slurry is adsorbed by the carrier polymer powder during the plasticization to form the pigment dispersoid.

In certain embodiments, when the carrier polymer powder is plasticized, a liquid phase in the pigment slurry is absorbed by the carrier polymer powder, and a solid phase in the pigment slurry is adsorbed by the carrier polymer powder.

In certain embodiments, an average particle size of the pigment powder in the pigment slurry ranges from 200 nm to 2000 nm.

In certain embodiments, a viscosity of the pigment slurry ranges from 100 cps to 750 cps.

In certain embodiments, the pigment slurry contains 20 phr to 40 phr of the pigment powder, 0.5 phr to 5 phr of the dispersant, and 50 phr to 80 phr of the plasticizer.

In certain embodiments, based on a total weight of the pigment slurry being 100 phr, an addition amount of the carrier polymer powder ranges from 110 phr to 150 phr.

In certain embodiments, an average particle size of the pigment dispersoid ranges from 0.05 mm to 5 mm.

In certain embodiments, the carrier polymer powder is selected from the group consisting of polyvinyl chloride, polyethylene wax, ethylene/vinyl acetate copolymer, polymethyl methacrylate, vinyl chloride/vinyl acetate copolymer, vinyl acetate/vinyl chloride/maleic acid copolymer, styrene/butadiene/acrylonitrile copolymer, and any combination thereof.

In another aspect, the present disclosure provides a pigment dispersoid. The pigment dispersoid is manufactured by the abovementioned method.

In certain embodiments, the pigment dispersoid includes a porous carrier formed from the carrier polymer powder. The pigment powder is attached on a total surface of the porous carrier.

Therefore, in the pigment dispersoid and the method for manufacturing the same of the present disclosure, by virtue of “homogenizing the dispersing solution to form a pigment slurry,” “stirring the liquid mixture at 80° C. to 100° C. to form the pigment dispersoid,” and “the pigment slurry being adsorbed by the carrier polymer powder to form the pigment dispersoid when the carrier polymer powder is plasticized,” the pigment dispersoid having the small average particle size, a uniform dispersity, and a high concentration of the pigment powder can be manufactured with low energy consumption.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing a pigment dispersoid; and

FIG. 2 is a schematic cross-sectional view of the pigment dispersoid of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In order to overcome the problem of high production cost of conventional pigment masterbatch and the difficulty for storing and processing pigment powder, a pigment dispersoid and a method for manufacturing the pigment dispersoid are provided in the present disclosure. In comparison with a conventional pigment powder, the pigment dispersoid of the present disclosure has advantages such as convenience of storage, a small particle size, a uniform dispersity, and a high pigment concentration. Therefore, the pigment dispersoid of the present disclosure can be fed in a production line (such as an extruder) during processes. Furthermore, compared with a conventional pigment masterbatch, the pigment dispersoid of the present disclosure can be manufactured at a low temperature, such that the production cost of the pigment dispersoid can be decreased.

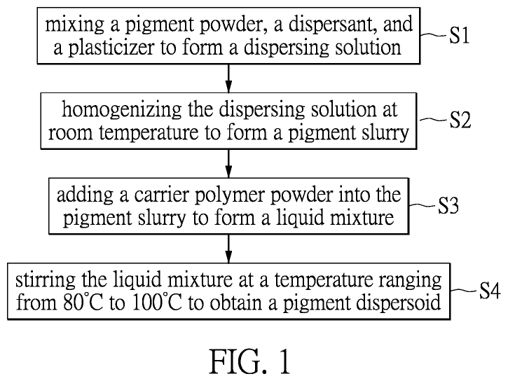

Referring to FIG. 1, the method for manufacturing the pigment dispersoid includes steps of: mixing pigment powder, a dispersant, and a plasticizer to form a dispersing solution (step S1), homogenizing the dispersing solution to form pigment slurry at room temperature (step S2), adding a carrier polymer powder into the pigment slurry to form a liquid mixture (step S3), and stirring the liquid mixture at a temperature ranging from 80° C. to 100° C. to form a pigment dispersoid (step S4).

A highest temperature when performing the method for manufacturing the pigment dispersoid is not over 100° C. (step S4). Compared with the conventional pigment masterbatch manufactured through a molten extrusion process, the pigment dispersoid of the present disclosure has a lower manufacturing temperature. Therefore, the method for manufacturing the pigment dispersoid of the present disclosure has an advantage of having low energy consumption.

The pigment dispersoid of the present disclosure is mainly formed from the carrier polymer powder, the pigment powder, and the plasticizer. By adjusting amounts and properties of the three components (the carrier polymer powder, the pigment powder, and the plasticizer), the three components can react with each other at a relatively low temperature (80° C. to 100° C.) so as to form a solid mixture (the pigment dispersoid) that has a stable structure.

When the liquid mixture is stirred, the plasticizer promotes a plasticization of the carrier polymer powder. During the plasticization, the pigment slurry is adsorbed by the carrier polymer powder such that the pigment powder is loaded by the carrier polymer powder.

Specifically, a liquid phase (i.e., the dispersant and the plasticizer) of the pigment slurry can be absorbed by the carrier polymer powder. Moreover, due to cohesion, the carrier polymer powder is gradually accumulated and then a porous carrier having an irregular shape is formed. When the liquid phase is completely absorbed, a solid phase (i.e., the pigment powder) of the liquid slurry is attached (adsorbed) on a surface of the porous carrier. The porous carrier is formed by accumulating a plurality of the carrier polymer powder, such that the pigment powder is attached on both an outer surface of the porous carrier and an inner surface surrounding pores formed in the porous carrier.

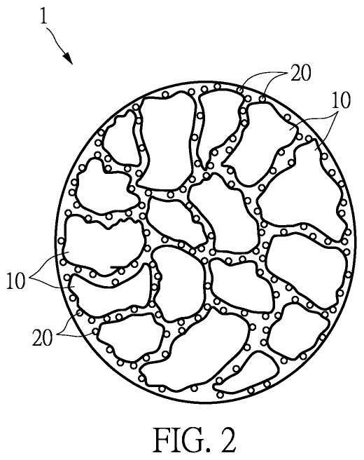

Referring to FIG. 2, from a microscopic perspective, a main structure of a pigment dispersoid 1 is formed from an accumulation of the carrier polymer powder 10 (to form the porous carrier) into an irregular shape. The pigment powder 20 is attached on a total surface of the porous carrier (the outer surface of the porous carrier and the inner surface surrounding pores formed in the porous carrier). From a macroscopic perspective, the pigment powder 20 can be regarded as either being encapsulated in the pigment dispersoid 1 or being adsorbed on the pigment dispersoid 1.

In other words, the pigment dispersoid of the present disclosure is mainly formed from the carrier polymer powder, the pigment powder, and the plasticizer. In a formation process of the pigment dispersoid, the three components are accumulated to form the solid mixture through interaction, rather than being reshaped or molded.

The conventional pigment masterbatch is manufactured through molten extrusion. Therefore, a polymer material is melted and then reshaped or molded, thereby forming a compact and imperforate pigment masterbatch. Specifically, the polymer material acts as a continuous phase in the conventional pigment masterbatch, and the pigment powder acts as a disperse phase in the conventional pigment masterbatch. In other words, the structure of the pigment dispersoid and the method for manufacturing the pigment dispersoid of the present disclosure are different from a structure and a method for manufacturing the conventional pigment masterbatch.

Referring to FIG. 1, in the step S1, for a convenience of forming the dispersing solution, after the dispersant and the plasticizer are mixed, the pigment powder can be added in small portions for multiple times, thereby preventing an accumulation of the pigment powder.

Based on a total weight of the dispersing solution being 100 wt %, an amount of the pigment powder ranges from 1 wt % to 75 wt %, an amount of the dispersant ranges from 0.05 wt % to 15 wt %, and an amount of the plasticizer ranges from 25 wt % to 99 wt %. In one exemplary embodiment, the amount of the pigment powder ranges from 20 wt % to 50 wt %, the amount of the dispersant ranges from 1 wt % to 10 wt %, and the amount of the plasticizer ranges from 40 wt % to 75 wt %.

It should be noted that the amount of the pigment powder can be adjusted according to various types of the pigment powder. For example, an amount of white pigment powder ranges from 45 wt % to 55 wt %, an amount of purple pigment powder ranges from 15 wt % to 20 wt %. Specifically, the amount of the pigment powder can be 25 wt %, 30 wt %, 35 wt %, 40 wt %, or 45 wt %. The amount of the plasticizer can be adjusted according to an amount of the carrier polymer powder. Specifically, the amount of the plasticizer can be 30 wt %, 35 wt %, 40 wt %, 45 wt %, 50 wt %, 55 wt %, 60 wt %, 65 wt %, or 70 wt %.

In the present disclosure, the pigment powder is not limited to being an organic material or an inorganic material. For example, the pigment powder can be titanium dioxide, zinc oxide, antimony trioxide, calcium carbonate, carbon black, graphite, iron oxide, aluminum bissilicate, copper sulfate, iron blue, ultramarine, phthalocyanine, sodium sulfate, barium sulfate, zinc sulfide, kaolin, lithopone, toluidine red, cadmium red, lead chromate yellow, cadmium yellow, iron yellow, benzidine yellow, chrome oxide green, chrome green, or azo pigments.

An addition of the dispersant can help disperse the pigment powder, and is beneficial to subsequent step S2 to step S4. The dispersant can be a polyamide, a polyamine, a phthalate, a citrate, an acetyl citrate, an ethylene-vinyl acetate copolymer wax, a paraffin wax, a polyethylene wax, a polypropylene wax, an oxidized polyethylene wax, an amide wax (e.g., oleamide, or erucamide), an ester wax (e.g., monoglyceride, pentaerythritol, or n-butyl stearate), a stearic acid, a stearate, a tribenzoate, a white mineral oil, or a silicone. However, the present disclosure is not limited thereto.

The addition of the plasticizer is to form the pigment dispersoid in step S4. Therefore, the pigment dispersoid of the present disclosure can be manufactured at a low temperature (e.g., from 80° C. to 100° C.) without being melted at a high temperature. The plasticizer can be dioctyl terephthalate (DOTP), di-iso-nonyl phthalate (DINP), di(2-propylheptyl) phthalate (DPHP), 1,2-cyclohexanedicarboxylate isononyl ester (DHIN), di(2-ethylhexyl)phthalate (DEHP), or epoxidized soybean oil. Preferably, the plasticizer can be dioctyl terephthalate or 1,2-cyclohexanedicarboxylate isononyl ester. However, the present disclosure is not limited thereto.

In step S2, the dispersing solution is homogenized at room temperature and at a rotation rate ranging from 300 rpm to 3000 rpm for 10 seconds to 600 seconds, so as to disperse the pigment powder and avoid the accumulation of the pigment powder.

After homogenization, an average particle size of the pigment powder in the pigment slurry ranges from 200 nm to 2000 nm. Preferably, the average particle size of the pigment powder in the pigment slurry ranges from 330 nm to 950 nm. The pigment powder in the pigment slurry and has an average particle size within the abovementioned range is suitable to form the pigment dispersoid that has an average particle size ranging from 0.1 mm to 0.6 mm. In addition, the pigment dispersoid has advantages of a high concentration of the pigment powder and a uniform dispersity of the pigment powder. In other embodiments, the average particle size of the pigment powder in the pigment slurry can be 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, or 1900 nm.

After homogenization, a viscosity of the pigment slurry is lower than or equal to 1000 cps, which is beneficial for subsequent step S3. In other embodiments, the viscosity of the pigment slurry can be 50 cps, 100 cps, 150 cps, 200 cps, 250 cps, 300 cps, 350 cps, 400 cps, 450 cps, 500 cps, 550 cps, 600 cps, 700 cps, 800 cps, or 900 cps.

In the present disclosure, the pigment slurry contains 1 phr to 75 phr of the pigment powder, 0.05 phr to 15 phr of the dispersant, and 25 phr to 99 phr of the plasticizer. In one exemplary embodiment, the pigment slurry contains 20 phr to 40 phr of the pigment powder, 0.5 phr to 5 phr of the dispersant, and 50 phr to 80 phr of the plasticizer. In another exemplary embodiment, the pigment slurry contains 10 phr to 30 phr of the pigment powder, 0.5 phr to 3 phr of the dispersant, and 50 phr to 70 phr of the plasticizer. In yet another exemplary embodiment, the pigment slurry contains 30 phr to 50 phr of the pigment powder, 2 phr to 5 phr of the dispersant, and 60 phr to 80 phr of the plasticizer.

In step S3, the carrier polymer powder is a main component of the pigment dispersoid. The main structure of the pigment dispersoid is composed of the porous carrier that is formed from the carrier polymer powder, and the pigment powder is adsorbed on the porous carrier. By using specific carrier polymer powder, the pigment dispersoid is more easily formed. For example, a material of the carrier polymer powder can be selected from the group consisting of: polyvinyl chloride, polyethylene wax, ethylene-vinyl acetate copolymer, polymethyl methacrylate, vinyl chloride-vinyl acetate copolymer, vinyl acetate-vinyl chloride-maleic acid copolymer, styrene-butadiene-acrylonitrile copolymer, and any combination thereof. However, the present disclosure is not limited thereto.

In one exemplary embodiment, a porous structure can be formed from the carrier polymer powder by a plasticization process or other processes. Accordingly, the porous carrier formed from the carrier polymer powder can have a better adsorbing effect to the pigment powder. In one exemplary embodiment, the material of the carrier polymer powder is polyvinyl chloride.

In one exemplary embodiment, a density of the carrier polymer powder ranges from 0.8 g/cm³ to 1.6 g/cm³, a specific surface area of the carrier polymer powder ranges from 10 m²/g to 70 m²/g, and an average particle size of the carrier polymer powder ranges from 0.1 mm to 1.0 mm By using the carrier polymer powder that has the abovementioned specifications, the pigment dispersoid can have the advantages of the small average particle size, the uniform dispersity, and the high concentration of the pigment powder.

In one exemplary embodiment, a functional additive, such as a stabilizer, can be added during step S3. An addition of the stabilizer can enhance a thermal resistance of the pigment dispersoid, such that an additional stabilizer is unnecessary to be added in the subsequent processes. For example, the stabilizer can be calcium-zinc-based antioxidants, barium-zinc-based antioxidants, thioester-based antioxidants, phosphite-based antioxidants, or phenolic antioxidants. However, the present disclosure is not limited thereto.

Based on a total weight of the pigment slurry being 100 phr, an amount of the carrier polymer powder can range from 110 phr to 150 phr, and an amount of the stabilizer can range from 0.5 phr to 5 phr. For example, the amount of the carrier polymer powder can be 120 phr, 130 phr, or 140 phr, and the amount of the stabilizer can be 1 phr, 2 phr, 3 phr, or 4 phr.

In step S4, the liquid mixture is stirred at the temperature ranging from 80° C. to 100° C. by a rotation rate ranging from 100 rpm to 2000 rpm for 300 seconds to 1200 seconds, and then the liquid mixture gradually becomes the pigment dispersoid in a solid state.

During a high-speed rotation process, in addition to absorbing the liquid phase of the pigment slurry and adsorbing the solid phase of the pigment slurry by the carrier polymer powder, the liquid mixture being stirred at the temperature ranging from 80° C. to 100° C. can also facilitate the carrier polymer powder to adsorb more of the pigment powder during plasticization. In other words, the method of the present disclosure can enhance the concentration of the pigment powder in the pigment dispersoid, and the pigment dispersoid can have a uniform dispersity.

During the high-speed rotation process, a part of the liquid phase is evaporated, thereby forming the pigment dispersoid of the present disclosure. In one exemplary embodiment, the average particle size of the pigment dispersoid ranges from 0.05 mm to 5 mm Preferably, the average particle size of the pigment dispersoid ranges from 0.1 mm to 2 mm More preferably, the average particle size of the pigment dispersoid ranges from 0.2 mm to 0.8 mm. For example, the average particle size of the pigment dispersoid can be 0.2 mm, 0.3 mm, 0.4 mm, 0.5 mm, 0.6 mm, 0.7 mm, 0.8 mm, 0.9 mm, 1 mm, 2 mm, 3 mm, or 4 mm. When the average particle size of the pigment dispersoid is too small, a dust may be formed from the pigment dispersoid during feeding. When the average particle size of the pigment dispersoid is too large, an amount of the pigment dispersoid that is added is difficult to be controlled, such that color dots may be formed on products.

In order to prove that the pigment dispersoid of the present disclosure can be manufactured at a low temperature and have the uniform dispersity of the pigment powder, the pigment dispersoids of Examples 1 to 6 are each manufactured according to the aforementioned step S1 to step S4 under different variables. Components and amounts of the components in each of Examples 1 to 6 are listed in Table 1. Unless otherwise specified, the units in Table 1 are parts by weight (phr). Properties of the pigment slurry and the pigment dispersoid used in each of Examples 1 to 6 are also listed in Table 1.

### Examples 1 to 6

After the dispersant and the plasticizer are mixed, the pigment powder is gradually added to the mixture so as to form the dispersing solution. The dispersing solution is homogenized at a rotation rate ranging from 300 rpm to 30000 rpm for 10 seconds to 600 seconds, so as to form the pigment slurry. The dispersant used in each of Examples 1 to 6 is a polyamide dispersant modified by a high molecular weight polyester or a polyamine dispersant modified by a high molecular weight polyester.

The pigment slurry contains 20 phr to 40 phr of the pigment powder, 0.5 phr to 5 phr of the dispersant, and 50 phr to 80 phr of the plasticizer. After the pigment slurry is homogenized, the viscosity of the pigment slurry ranges from 100 cps to 750 cps, and the average particle size of the pigment powder in the pigment slurry ranges from 200 nm to 2000 nm.

Subsequently, based on the total weight of the pigment slurry being 100 phr, 110 phr to 150 phr of the carrier polymer powder and 0.5 phr to 5 phr of the stabilizer are added into the pigment slurry, such that the liquid mixture is formed. The liquid mixture is stirred at the temperature ranging from 80° C. to 100° C. by the rotation rate ranging from 100 rpm to 2000 rpm for 300 seconds to 1200 seconds so as to form the pigment dispersoid. The average particle size of the pigment dispersoid ranges from 0.05 mm to 5 mm

TABLE 1

| | | Example | | | | | |
|---|---|---|---|---|---|---|---|
| (phr) | | 1 | 2 | 3 | 4 | 5 | 6 |
| Pigment | Black pigment powder | 30 | 30 | — | 30 | 30 | 30 |
| powder | Blue pigment powder | — | — | 30 | — | — | — |
| Dispersant | Polyamide dispersant | 2.4 | — | — | 2.4 | 2.4 | 2.4 |
| | Polyamine dispersant | — | 2.4 | 2.4 | — | — | — |
| Plasticizer | Diisooctyl terephthalate | 67.6 | 67.6 | 67.6 | — | 67.6 | 67.6 |
| | 1,2-cyclohexanedicarboxylate | — | — | — | 67.6 | — | — |
| | isononyl ester | | | | | | |
| Average particle size of the pigment | | 472 | 891 | 356 | 527 | 472 | 472 |
| powder in the pigment slurry (nm) | | | | | | | |
| Viscosity of the pigment slurry (cps) | | 220 | 680 | 200 | 560 | 220 | 220 |
| Stabilizer | Calcium-zinc-based | 1.8 | 1.8 | 1.8 | 1.8 | 1.8 | — |
| | antioxidant | | | | | | |
| | Barium-zinc-based | — | — | — | — | — | 1.8 |
| | antioxidant | | | | | | |
| Carrier | Polyvinyl chloride powder | 120 | 120 | 120 | 120 | — | 120 |
| polymer | Polyethylene wax powder | — | — | — | — | 120 | — |
| powder | | | | | | | |

| | | | | | | |
|---|---|---|---|---|---|---|
| Average particle size of the pigment | 0.32 | 0.34 | 0.30 | 0.32 | 0.60 | 0.32 |
| dispersoid (mm) | | | | | | |

Based on results of Table 1, after the pigment slurry is homogenized, the average particle size of the pigment powder in the pigment slurry ranges from 350 nm to 550 nm, the viscosity of the pigment slurry ranges from 180 cps to 720 cps, and the average particle size of the pigment dispersoid ranges from 0.25 mm to 0.65 mm.

When the material of the carrier polymer powder is polyvinyl chloride powder, the pigment dispersoid can have a smaller average particle size ranging from 0.25 mm to 0.45 mm Preferably, the average particle size of the pigment dispersoid ranges from 0.25 mm to 0.35 mm.

Compared to the conventional pigment masterbatch, the pigment dispersoid of the present disclosure has a smaller average particle size, such that the pigment dispersoid is suitable to be metered by automatic metering machine. Therefore, the pigment dispersoid can be optionally fed at a device end of an extruder (i.e., side fed). In other words, a main production line does not need to be washed after changing a pigment color.

### Beneficial Effects of the Embodiments

In conclusion, in the pigment dispersoid and the method for manufacturing the same of the present disclosure, by virtue of “homogenizing the dispersing solution to form a pigment slurry,” and “the pigment slurry being adsorbed by the carrier polymer powder to form the pigment dispersoid when the carrier polymer powder is plasticized,” the pigment dispersoid having the small average particle size, the uniform dispersity, and the high concentration of the pigment powder can be manufactured with low energy consumption.

Further, by virtue of homogenization, the pigment powder can be uniformly dispersed in the pigment dispersoid to have the average particle size ranging from 200 nm to 2000 nm, such that the pigment dispersoid having the small average particle size can be manufactured. Despite the pigment dispersoid having the small average particle size, by adding the plasticizer to plasticize the carrier polymer powder, the concentration of the pigment powder of the pigment dispersoid can be increased and the uniform dispersity of the pigment powder in the pigment dispersoid can be maintained.

Further, by virtue of adjusting a relative amount of the pigment slurry and the carrier polymer powder, or adjusting a relative amount of the pigment powder, the dispersant, and the plasticizer of the pigment slurry, the pigment dispersoid of the present disclosure can have advantages of the small average particle size, uniform dispersity, and high concentration of the pigment powder.

Further, by virtue of stirring the liquid mixture at 80° C. to 100° C., the plasticizer prompts a plasticization of the carrier polymer powder such that the carrier polymer powder can adsorb more pigment powder and remove more liquid phase of the pigment slurry, thereby forming the pigment dispersoid of the present disclosure.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing a pigment dispersoid, comprising:
mixing pigment powder, a dispersant, and a plasticizer to form a dispersing solution;
homogenizing the dispersing solution to form a pigment slurry;
adding a carrier polymer powder into the pigment slurry to form a liquid mixture; and
stirring the liquid mixture at a temperature ranging from 80° C. to 100° C. to form a pigment dispersoid;
wherein the plasticizer promotes a plasticization of the carrier polymer powder such that the pigment slurry is adsorbed by the carrier polymer powder during the plasticization to form the pigment dispersoid.

2. The method according to claim 1, wherein, when the carrier polymer powder is plasticized, a liquid phase in the pigment slurry is absorbed by the carrier polymer powder, and a solid phase in the pigment slurry is adsorbed by the carrier polymer powder.

3. The method according to claim 1, wherein an average particle size of the pigment powder in the pigment slurry ranges from 200 nm to 2000 nm.

4. The method according to claim 1, wherein a viscosity of the pigment slurry ranges from 100 cps to 750 cps.

5. The method according to claim 1, wherein the pigment slurry contains 20 phr to 40 phr of the pigment powder, 0.5 phr to 5 phr of the dispersant, and 50 phr to 80 phr of the plasticizer.

6. The method according to claim 1, wherein, based on a total weight of the pigment slurry being 100 phr, an addition amount of the carrier polymer powder ranges from 110 phr to 150 phr.

7. The method according to claim 1, wherein an average particle size of the pigment dispersoid ranges from 0.05 mm to 5 mm.

8. The method according to claim 1, wherein the carrier polymer powder is selected from the group consisting of: polyvinyl chloride, polyethylene wax, ethylene/vinyl acetate copolymer, polymethyl methacrylate, vinyl chloride/vinyl acetate copolymer, vinyl acetate/vinyl chloride/maleic acid copolymer, styrene/butadiene/acrylonitrile copolymer, and any combination thereof.

9. A pigment dispersoid manufactured by the method as claimed in claim 1.

10. The pigment dispersoid according to claim 9, comprising a porous carrier formed from the carrier polymer powder, wherein the pigment powder is attached on a total surface of the porous carrier.
